(19) United States
(12) Patent Application Publication
(10) Pub. No.: US 2021/0286475 A1
(43) Pub. Date: Sep. 16, 2021

(54) METHOD AND SYSTEM FOR GENERATING A USER INTERFACE FOR MANAGING A DATA SET

(71) Applicant: JPMorgan Chase Bank, N.A., New York, NY (US)

(72) Inventors: Trivedi KETINENI, Robbinsville, NJ (US); Amar SHAH, Glasgow (GB); Rahul SUDHAKARAN, Jersey City, NJ (US)

(73) Assignee: JPMorgan Chase Bank, N.A., New York, NY (US)

(21) Appl. No.: 17/199,817

(22) Filed: Mar. 12, 2021

Related U.S. Application Data
(60) Provisional application No. 62/989,161, filed on Mar. 13, 2020.

(51) Int. Cl. G06F 3/0481

(52) U.S. Cl. CPC G06F 3/0481

(57) ABSTRACT

A method and computing apparatus for generating a user interface for managing a data set are provided. The method includes receiving a request to manage the data set, prompting a user to provide at least one input that relates to a parameter for managing the first set of data; receiving the at least one input; and generating the user interface based on the received at least one input and information that relates to the first set of data.

### CROSS-REFERENCE TO RELATED APPLICATIONS

This application claims the benefit of U.S. Provisional Patent Application Ser. No. 62/989,161, filed Mar. 13, 2020, which is hereby incorporated by reference in its entirety.

### BACKGROUND

### 1. Field of the Disclosure

This technology generally relates to methods and systems for rapidly generating a user interface for managing a data set.

### 2. Background Information

A common problem within an organization is an inability to efficiently and accurately manage and administer data. Typically, at least one member of the organization controls the data (“data controller(s)”) and at least one member of the organization manages and/or administers the data (“data manager(s)”). Without user interfaces for managing and administering data, the data manager(s) must request for the data controller(s) to write ad hoc code every time the data manager(s) manages or administers data. The writing of the ad hoc code takes considerable time and is subject to human error. Accordingly, many organizations have frequent requests to provide user interface(s) for managing and administering data.

Accordingly, there is a need to efficiently and accurately generate a user interface for managing data.

### SUMMARY

The present disclosure, through one or more of its various aspects, embodiments, and/or specific features or sub-components, provides, inter alia, various systems, servers, devices, methods, media, programs, and platforms for generating a user interface for managing a data set.

According to an exemplary embodiment, a method for generating a user interface for managing a data set is provided. The method is implemented by at least one processor. The method includes: receiving a request to manage a first set of data; prompting a user to provide at least one input that relates to a parameter for managing the first set of data; receiving the at least one input; and generating the user interface based on the received at least one input and information that relates to the first set of data.

The generating of the user interface may include generating a plurality of pages.

The plurality of pages may provide user capabilities including at least one of listing the plurality of pages, creating at least one additional page, editing at least one page of the plurality of pages, deleting the at least one page of the plurality of pages, providing search parameters, providing grid filtering, providing grid sorting, and providing pagination.

The user capabilities may further include at least one from among an add action, an update action, and a delete action.

The generating the user interface may include using Structured Query Language (SQL) to generate the user interface.

The generating of the user interface may be based on an output of at least one microservice.

The at least one input may include at least one from among a business date, a source run identification value, and a source.

The at least one input may include at least one from among a client identification, a client name, a client description, a Create, Read, Delete (CRD) identification value, a File Transfer Protocol (FTP) user name, a destination folder, a File Transfer Services (FTS) type, and an identification source.

The user interface may be configured to record at least one from among at least one user metric and user usage.

According to another exemplary embodiment, a computing apparatus for generating a user interface for managing at least one data set is provided. The computing apparatus includes a processor; a memory; and a communication interface coupled to each of the processor and the memory. The processor is configured to: receive, via the communication interface, a request to manage a first set of data; prompt a user to provide at least one input that relates to a parameter for managing the first set of data; receive, via the communication interface, the at least one input; and generate the user interface based on the received at least one input and information that relates to the first set of data.

The processor may be further configured to generate a plurality of pages.

The plurality of pages may provide user capabilities including at least one from among listing the plurality of pages, creating at least one additional page, editing at least one page of the plurality of pages, deleting the at least one page of the plurality of pages, providing search parameters, providing grid filtering, providing grid sorting, and providing pagination.

The user capabilities may further include at least one from among an add action, an update action, and a delete action.

The processor may be further configured to use Structured Query Language (SQL) to generate the user interface.

The processor may be further configured to generate the user interface based on an output of at least one microservice.

The at least one input may include at least one from among a business date, a source run identification value, and a source.

The at least one input may include at least one from among a client identification, a client name, a client description, a Create, Read, Delete (CRD) identification value, a File Transfer Protocol (FTP) user name, a destination folder, a File Transfer Services (FTS) type, and an identification source.

The user interface may be configured to record at least one from among at least one user metric and user usage.

According to yet another exemplary embodiment, a non-transitory computer readable storage medium storing instructions for generating a user interface for managing at least one data set is provided. The storage medium includes executable code which, when executed by a processor, causes the processor to: receive a request to manage a first set of data; prompt a user to provide at least one input that relates to a parameter for managing the first set of data; receive the at least one input; and generate the user interface based on the received at least one input and information that relates to the first set of data.

When executed by the processor, the executable code may further cause the processor to generate a plurality of pages that provide user capabilities.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for generating a user interface for managing a data set.

FIG. 4 is a flowchart of an exemplary process for implementing a method for generating a user interface for managing a data set.

FIG. 5 shows an exemplary image of a display of a first prompt for a user to provide at least one input that relates to a parameter for managing a data set.

FIG. 6 shows an exemplary image of a display of a second prompt for a user to provide at least one input that relates to a parameter for managing a data set.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

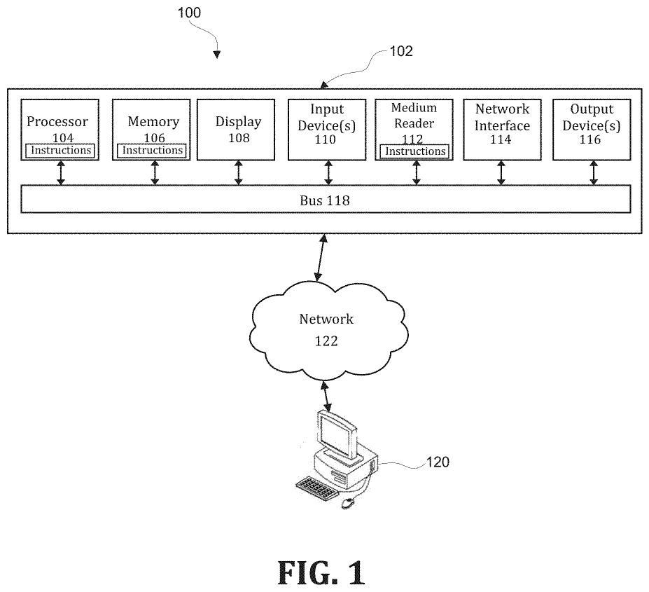

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

As described herein, various embodiments provide optimized methods and systems for generating a user interface for managing a data set.

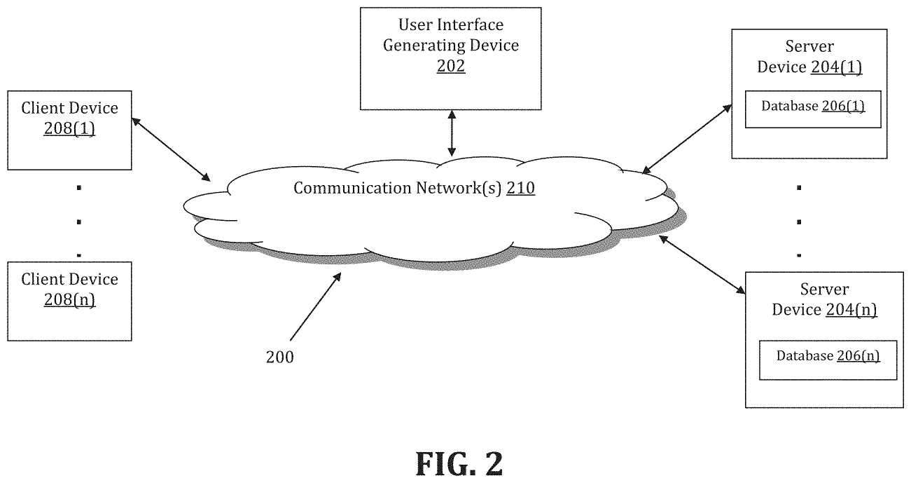

Referring to FIG. 2, a schematic of an exemplary network environment 200 for implementing a method for generating a user interface for managing a data set is illustrated. In an exemplary embodiment, the method is executable on any networked computer platform, such as, for example, a personal computer (PC).

The method for generating a user interface for managing a data set may be implemented by a User Interface Generating (UIG) device 202. The UIG device 202 may be the same or similar to the computer system 102 as described with respect to FIG. 1. The UIG device 202 may store one or more applications that can include executable instructions that, when executed by the UIG device 202, cause the UIG device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the UIG device 202 itself, may be located in virtual server(s) running in a cloud-based computing environment rather than being tied to one or more specific physical network computing devices. Also, the application(s) may be running in one or more virtual machines (VMs) executing on the UIG device 202. Additionally, in one or more embodiments of this technology, virtual machine(s) running on the UIG device 202 may be managed or supervised by a hypervisor.

In the network environment 200 of FIG. 2, the UIG device 202 is coupled to a plurality of server devices 204(1)-204(n) that hosts a plurality of databases 206(1)-206(n), and also to a plurality of client devices 208(1)-208(n) via communication network(s) 210. A communication interface of the UIG device 202, such as the network interface 114 of the computer system 102 of FIG. 1, operatively couples and communicates between the UIG device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the UIG device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and UIG devices that efficiently implement a method for generating a user interface for managing a data set.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The UIG device 202 may be a standalone device or integrated with one or more other devices or apparatuses, such as one or more of the server devices 204(1)-204(n), for example. In one particular example, the UIG device 202 may include or be hosted by one of the server devices 204(1)-204(n), and other arrangements are also possible. Moreover, one or more of the devices of the UIG device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the UIG device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to generating a user interface for managing a data set.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the UIG device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the UIG device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the UIG device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the UIG device 202, the server devices 204(1)-204(n), or the client devices 208(1)-208(n), for example, may be configured to operate as virtual instances on the same physical machine. In other words, one or more of the UIG device 202, the server devices 204(1)-204(n), or the client devices 208(1)-208(n) may operate on the same physical device rather than as separate devices communicating through communication network(s) 210. Additionally, there may be more or fewer UIG devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

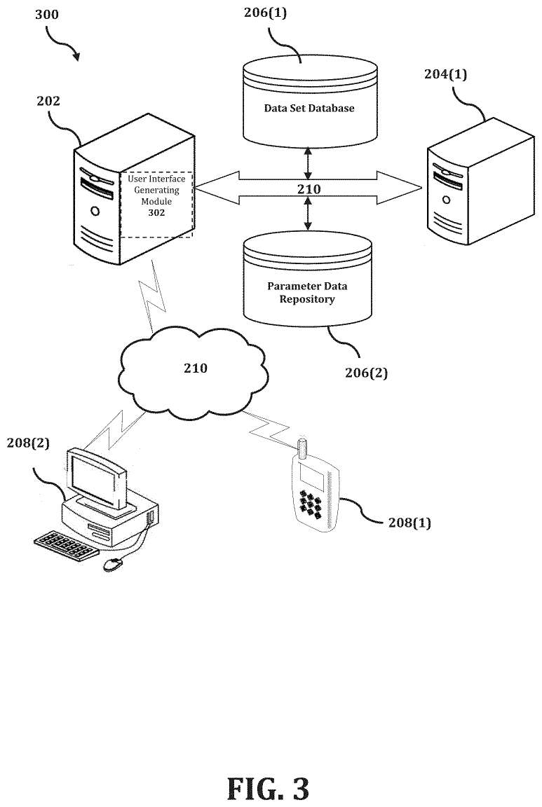

The UIG device 202 is described and shown in FIG. 3 as including a User Interface Generating module 302, although it may include other rules, policies, modules, databases, or applications, for example. As will be described below, the User Interface Generating module 302 is configured to implement a method for generating a user interface for managing a data set.

An exemplary process 300 for implementing a mechanism for generating a user interface for managing a data set by utilizing the network environment of FIG. 2 is shown as being executed in FIG. 3. Specifically, a first client device 208(1) and a second client device 208(2) are illustrated as being in communication with UIG device 202. In this regard, the first client device 208(1) and the second client device 208(2) may be “clients” of the UIG device 202 and are described herein as such. Nevertheless, it is to be known and understood that the first client device 208(1) and/or the second client device 208(2) need not necessarily be “clients” of the UIG device 202, or any entity described in association therewith herein. Any additional or alternative relationship may exist between either or both of the first client device 208(1) and the second client device 208(2) and the UIG device 202, or no relationship may exist.

According to an exemplary embodiment, client devices 208(1)-208(n) may be embodied by or related to a plurality of user devices. In an exemplary embodiment, a user device of the plurality of user devices may be associated with at least one individual of an organization. In another exemplary embodiment, a user device of the plurality of user devices may be associated with at least one group of individuals of the organization. In yet another exemplary embodiment, a user device of the plurality of user devices may be associated with a location such as, e.g., an organization's headquarters, an organization's corporate office, an organization's retail location, an organization's sales office, an organization's administrative office, an organization's field office, or a home office of an individual of an organization.

In an exemplary embodiment, UIG device 202 is illustrated as being able to access a data set database 206(1) and a parameter data repository 206(2). The User Interface Generating module 302 may be configured to access these databases for implementing a method for generating a user interface for managing a data set.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the UIG device 202 via broadband or cellular communication. Of course, these embodiments are merely exemplary and are not limiting or exhaustive.

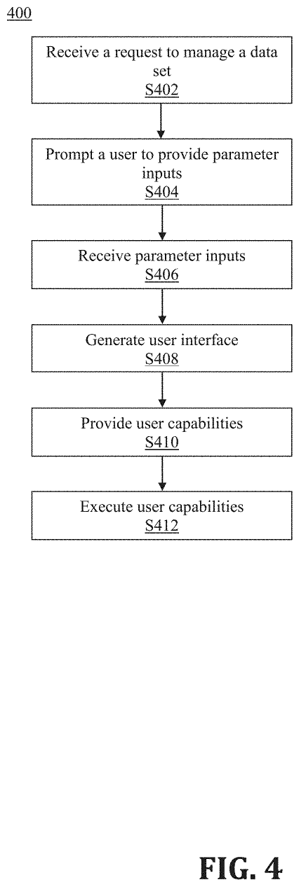

Upon being started, the User Interface Generating module 302 executes a process for generating a user interface for managing a data set. An exemplary process for generating a user interface for managing a data set is generally indicated at flowchart 400 in FIG. 4.

In the process 400 of FIG. 4, at step S402, the User Interface Generating module 302 obtains or receives a request to manage a first set of data. In an exemplary embodiment, the request may be submitted by a user of the organization such as, e.g., a member of the organization authorized to manage and/or administer data.

At step S404, the User Interface Generating module 302 prompts a user to provide at least one input that relates to a parameter for managing the first set of data. In an exemplary embodiment, the user prompted for the at least one input is the member of the organization that submitted the request to manage the first set of data. In another exemplary embodiment, other members of the organization may be prompted to provide various inputs.

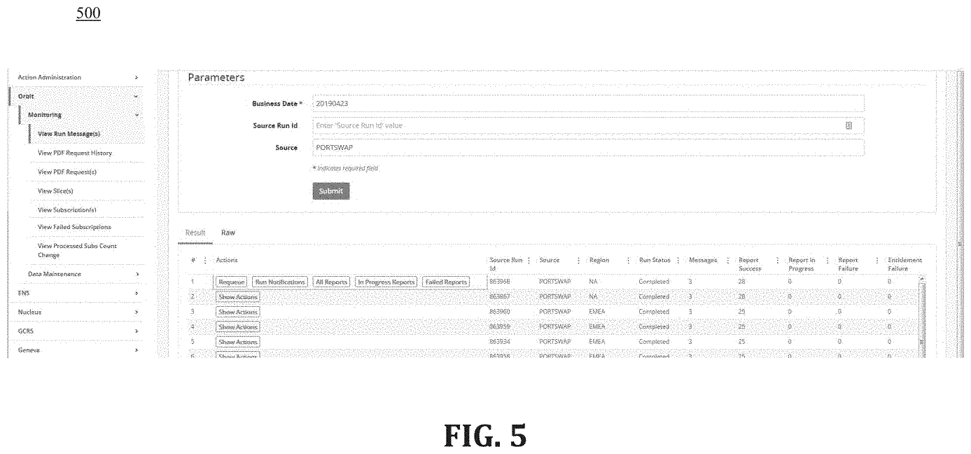

As illustrated in FIG. 5, according to an exemplary embodiment, the at least one input that relates to the parameter for managing the first set of data includes at least one of a data field that relates to a business date, a data field that relates to a source run identification value, and a data field that relates to a source. In an exemplary embodiment, the at least one input that relates to the parameter for managing the first set of data may include at least one required input. In an exemplary embodiment, the at least one required input may include the data field that relates to a business date.

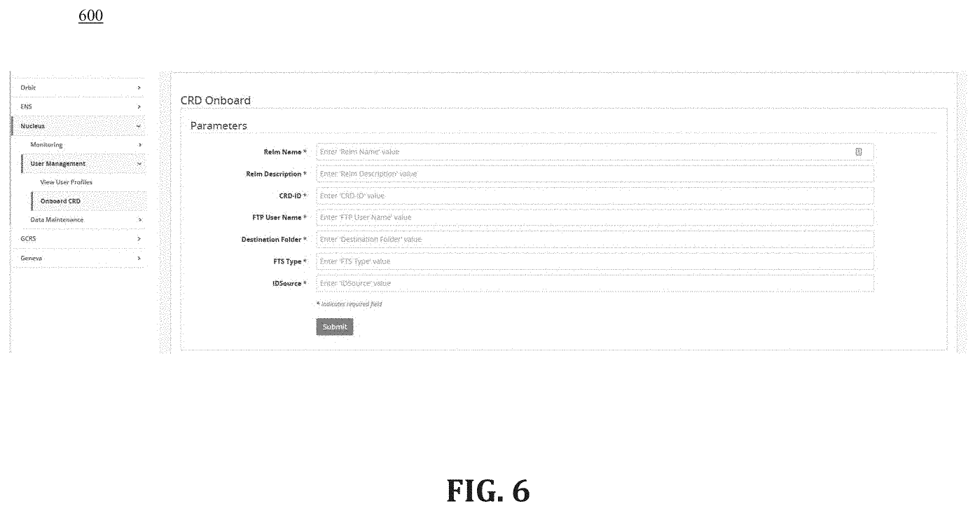

As illustrated in FIG. 6, according to an exemplary embodiment, the at least one input that relates to the parameter for managing the first set of data includes at least one of a data field that relates to an identification (ID) of a client of an organization (“Relm”), a name of a client of an organization (“Relm name”), a data field that relates to a description of a client of an organization (“Relm description”), a data field that relates to a Create, Read, Delete (CRD) identification value, a data field that relates to a File Transfer Protocol (FTP) user name, a data field that relates to a destination folder, a data field that relates to a File Transfer Services (FTS) type, and a data field that relates to an identification source. In an exemplary embodiment, the at least one input that relates to the parameter for managing the first set of data may include at least one required input. In an exemplary embodiment, the at least one required input may include at least one of the data field that relates to the Relm name, the data field that relates to the Relm description, the data field that relates to the CRD identification value, the data field that relates to the FTP user name, the data field that relates to the destination folder, the data field that relates to the FTS type, and the data field that relates to the identification source.

At step S406, the User Interface Generating module 302 receives the input relating to the parameter for managing the data set. As illustrated in FIGS. 5 and 6, there may be provided a “submit” button. According to an exemplary embodiment, the User Interface Generating module 302 receives the input relating to the parameter for managing the data set upon the user inputting one or more of the aforementioned data fields and subsequently activating or clicking a submit button. In another exemplary embodiment, the activation of a submit button is not necessary for the Interface Generating module 302 to receive an input relating to the parameter for managing the data set.

At step S408, the User Interface Generating module 302 generates a user interface based on the received at least one input and information that relates to the data set. In an exemplary embodiment, the generated user interface pages provide user capabilities including at least one of a create operation, a read operation, an update operation, and a delete operation.

In an exemplary embodiment, the generating of the user interface includes generating a plurality of pages. In an exemplary embodiment, at least one of the generated plurality of pages may provide user capabilities including at least one of listing the plurality of pages, creating at least one additional page, editing at least one page of the plurality of pages, deleting the at least one page of the plurality of pages, providing search parameters, providing grid filtering, providing grid sorting, and providing pagination. In an exemplary embodiment, at least one page of the plurality of generated pages may include at least one of a nested page, a child page, a parent page, and a dependent page.

In an exemplary embodiment, the generation of the user interface includes generating at least one configurable user interface menu. In another exemplary embodiment, the generated at least one configurable user interface menu relates to administrative privileges of at least one user.

In an exemplary embodiment, the generation of the user interface for managing a data set includes generating a user interface that records at least one of user metrics and user usage. In another exemplary embodiment, the generated user interface provides a user capability of auditing the at least one of the user metrics and user usage.

In another exemplary embodiment, the generating the user interface includes using Structured Query Language (SQL). In an exemplary embodiment, the User Interface Generating module 302 generates user interface pages based on SQL output. In an exemplary embodiment, the User Interface Generating module 302 generates a user interface that provides user capabilities including at least one of listing a plurality of generated user interface pages, editing at least one page of the plurality of pages, and deleting the at least one page of the plurality of pages. In an exemplary embodiment, when the User Interface Generating module 302 receives a request to manage data from, e.g., a member of an organization such as, e.g., a business user or a production management personnel, the User Interface Generating module 302 may prompt the member of the organization or another member of the organization to input an input relating to a parameter for managing the data set in the form of SQL; and upon receiving the input, the User Interface Generating module 302 may generate a user interface to satisfy the request to manage data.

In yet another exemplary embodiment, the generating of the user interface is based on an output of at least one microservice.

At step S410, User Interface Generating module 302 provides user capabilities including at least one of listing the plurality of pages, creating at least one additional page, editing at least one page of the plurality of pages, deleting the at least one page of the plurality of pages, providing search parameters, providing grid filtering, providing grid sorting, and providing pagination.

At step S412, User Interface Generating module 302 executes the user capabilities provided in step S410. In an exemplary embodiment, the user may select at least one capability to be executed by the User Interface Generating module 302. For example, upon selection of an add action, an update action, or a delete action, the User Interface Generating module 302 executes the selected action.

Accordingly, with this technology, an optimized process for generating a user interface for managing a data set is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for generating a user interface for managing at least one data set, the method being implemented by at least one processor, the method comprising:
receiving, by the at least one processor, a request to manage a first set of data;
prompting, by the at least one processor, a user to provide at least one input that relates to a parameter for managing the first set of data;
receiving, by the at least one processor, the at least one input; and
generating, by the at least one processor, the user interface based on the received at least one input and information that relates to the first set of data.

2. The method of claim 1, wherein the generating of the user interface includes generating a plurality of pages.

3. The method of claim 2, wherein the plurality of pages provide user capabilities including at least one from among listing the plurality of pages, creating at least one additional page, editing at least one page of the plurality of pages, deleting the at least one page of the plurality of pages, providing search parameters, providing grid filtering, providing grid sorting, and providing pagination.

4. The method of claim 3, wherein the user capabilities further include at least one from among an add action, an update action, and a delete action.

5. The method of claim 1, wherein the generating of the user interface comprises using Structured Query Language (SQL) to generate the user interface.

6. The method of claim 1, wherein the generating of the user interface is based on an output of at least one microservice.

7. The method of claim 1, wherein the at least one input includes at least one from among a business date, a source run identification value, and a source.

8. The method of claim 1, wherein the at least one input includes at least one from among a client identification, a client name, a client description, a Create, Read, Delete (CRD) identification value, a File Transfer Protocol (FTP) user name, a destination folder, a File Transfer Services (FTS) type, and an identification source.

9. The method of claim 1, wherein the user interface is configured to record at least one from among at least one user metric and user usage.

10. A computing apparatus for generating a user interface for managing at least one data set, the computing apparatus comprising:
a processor;
a memory; and
a communication interface coupled to each of the processor and the memory,
wherein the processor is configured to:
receive, via the communication interface, a request to manage a first set of data;
prompt a user to provide at least one input that relates to a parameter for managing the first set of data;
receive, via the communication interface, the at least one input; and
generate the user interface based on the received at least one input and information that relates to the first set of data.

11. The computing apparatus of claim 10, wherein the processor is further configured to generate a plurality of pages.

12. The computing apparatus of claim 11, wherein the plurality of pages provide user capabilities including at least one from among listing the plurality of pages, creating at least one additional page, editing at least one page of the plurality of pages, deleting the at least one page of the plurality of pages, providing search parameters, providing grid filtering, providing grid sorting, and providing pagination.

13. The computing apparatus of claim 12, wherein the user capabilities further include at least one from among an add action, an update action, and a delete action.

14. The computing apparatus of claim 10, wherein the processor is further configured to use Structured Query Language (SQL) to generate the user interface.

15. The computing apparatus of claim 10, wherein the processor is further configured to generate the user interface based on an output of at least one microservice.

16. The computing apparatus of claim 10, wherein the at least one input includes at least one from among a business date, a source run identification value, and a source.

17. The computing apparatus of claim 10, wherein the at least one input includes at least one from among a client identification, a client name, a client description, a Create, Read, Delete (CRD) identification value, a File Transfer Protocol (FTP) user name, a destination folder, a File Transfer Services (FTS) type, and an identification source.

18. The computing apparatus of claim 10, wherein the user interface is configured to record at least one from among at least one user metric and user usage.

19. A non-transitory computer readable storage medium storing instructions for generating a user interface for managing at least one data set, the storage medium comprising executable code which, when executed by a processor, causes the processor to:
receive a request to manage a first set of data;
prompt a user to provide at least one input that relates to a parameter for managing the first set of data;
receive the at least one input; and
generate the user interface based on the received at least one input and information that relates to the first set of data.

20. The storage medium of claim 19, wherein when executed by the processor, the executable code further causes the processor to generate a plurality of pages that provide user capabilities.
